(19) United States
(12) Patent Application Publication
(10) Pub. No.: US 2006/0215844 A1
(43) Pub. Date: Sep. 28, 2006

(54) Method and device to optimize an audio sound field for normal and hearing-impaired listeners

(76) Inventor: Susan E. Voss, Northampton, MA (US)

Correspondence Address: MCCORMICK, PAULDING & HUBER LLP, CITY PLACE II, 185 ASYLUM STREET, HARTFORD, CT, 06103, US

(21) Appl. No.: 11/377,014

(22) Filed: Mar. 16, 2006

Related U.S. Application Data
(60) Provisional application No. 60/662,763, filed on Mar. 16, 2005.

(51) Int. Cl. H04R 29/00

(52) U.S. Cl. 381/60

(57) ABSTRACT

A method to optimize the audio sound field for normal and hearing-impaired listeners are disclosed. The approach allows for the determination of the characteristics of the frequency response of the audio system and any hearing impairment of the listener. These characteristics define a hearing profile that can be applied to customize audio products.

### CROSS REFERENCE TO RELATED APPLICATIONS

This application claims the benefit of U.S. Provisional Application Ser. No. 60/662,763, filed on Mar. 16, 2005, and herein incorporated by reference in its entirety.

### FIELD OF THE INVENTION

The present invention relates in general to methods and systems for filtering and amplifying audio signals to improve the listening environment for both normal and hearing-impaired persons.

### BACKGROUND OF THE INVENTION

Numerous audio systems (including but not limited to home, car, portable, computer based, personal listening devices) are used to transmit signals (such as music or speech), and these systems can all have dramatically different frequency responses, causing the signals to sound different depending on the system used. Some of these systems include built-in audio equalization systems that have been designed to alter the spectrum of the audio signal for improved listening experiences. Such equalization systems typically account for the frequency characteristics of the audio system itself, and many systems include specific choices for different types of music, including, but not limited to, jazz, pop, disco, rock, or user defined. The “user defined” option does not permit a systematic method for optimizing the output spectrum for individual listeners; instead it generally relies on subjective impressions of the audio output. The present invention consists of a method and a device that permits a systematic optimization procedure that accounts for both the frequency response of the audio system as well as the frequency response of the listener. Thus, the invention compensates for hearing impairments and/or audio equipment that introduces distortion into the audio output.

Fifteen percent of the American population suffers from some degree of hearing loss. However, due to social stigma associated with hearing loss, cost, and availability, only about 10% of people who might benefit from a hearing aid actually own one.

Human hearing is sensitive to the range of frequencies from 20 Hz to 20,000 Hz. The frequency range most important for the perception of speech and music is about 300 Hz to 8000 Hz. As a comparison, telephone signals only carry frequencies between 300 and 3000 Hz, and people with normal hearing generally hear most information via a telephone connection. People with hearing loss often have different levels of loss at different frequencies, which leads to sounds being perceived as distorted relative to a normal-hearing individual because the various frequency components are not weighted in the expected manner. Thus, turning up the volume on a stereo or other audio device does not generally correct for the hearing loss. A classic example of hearing loss is the noise-induced loss that results from repeated exposure to gunshots; in this case, hearing is typically poor above about 2000 Hz and is often normal at lower frequencies.

The conventional hearing test is an audiogram, which is typically measured by trained professionals with expensive and carefully calibrated equipment. An audiogram measures a person's hearing sensitivity at several discrete frequencies. To compensate for hearing loss that varies with frequency, hearing aids can be fit to an individual's audiogram so that different gains are applied to different frequency bands. Such a fit allows the hearing-aid user to listen to an audio field that is similar to what a normal-hearing listener would hear. The process of fitting a hearing aid must be done by an audiologist, it involves specialized equipment and testing, and it is costly.

A variety of devices aim to modify the frequency content of audio signals for hearing-impaired listeners. For example, hearing profiles (e.g., audiograms) of individuals can be used for fitting hearing aids and also for producing customized audio products, such as pre-recorded music that has been modified according to the hearing profile of the listener. One medium for delivering customized audio products is the Internet, and several recent patents provide methods for modifying the spectrum of an audio signal from a remote server before the signal is transmitted, for example U.S. Pat. No. 6,840,908, entitled SYSTEM AND METHOD FOR REMOTELY ADMINISTERED, INTERACTIVE HEARING TESTS invented by Edwards et al, U.S. Pat. No. 6,522,988, entitled METHOD AND SYSTEM FOR ON-LINE HEARING EXAMINATION USING CALIBRATED LOCAL MACHINE, invented by Hou, and U.S. Pat. No. 6,724,862 entitled METHOD AND APPARATUS FOR CUSTOMIZING A DEVICE BASED ON A FREQUENCY RESPONSE FOR A HEARING-IMPAIRED USER, invented by Shaffer et al.

All of these earlier inventions require either (1) prior knowledge of a person's hearing profile or (2) a calibration mechanism used in conjunction with the invention to measure hearing thresholds (i.e., absolute thresholds). In contrast, the present invention uniquely utilizes the relative thresholds between multiple frequency bands of hearing. Thus, it is a stand-alone system that does not require absolute calibration.

### SUMMARY OF THE INVENTION

The present invention provides a device and a method that allows a person to optimize the sound field produced by an audio system. The optimization process accounts for both the frequency response of the audio system (e.g., the speakers, headphones, etc.) and also any hearing impairment of the listener. The device does not require any external calibration equipment.

In one embodiment, the invention is a stand-alone system that includes audio generation capabilities (e.g., computer sound card, stereo system, CD player, radio, personal listening device, etc.) and an audio output such as speakers or headphones. Within the system, between the audio generation and the audio output, is a filter bank that is programmed interactively by the user. A systematic procedure is employed in which the user listens to several individual tones, which have relative amplitudes adjusted to correspond with, for example, normal-hearing auditory thresholds. While listening to each individual tone, the user adjusts the gains of the filter bank so that each tone is just barely audible. The filter specifications for the given individual are then stored within the system and used to modify the output audio signal.

In another embodiment, the invention is a sound track, stored for example on a CD or a computer, that can be used in conjunction with additional audio equipment such as a commercially-available equalizer or computer-based equalizer system. In this case, the sound track provides individual tones that are scaled with relative amplitudes adjusted, for example, to correspond with normal-hearing auditory thresholds in a manner that allows the user to optimize the audio output of the audio system and that individual's hearing profile.

In combination with all embodiments, the audio system may include memory that allows the individual specifications to be saved for a number of users and recalled for each user at a later time.

In combination with all embodiments, the audio system may include the ability to record the filtered signal so that it may be stored and replayed without additional filtering.

In combination with all embodiments, the systematic procedure to setting the filter banks might use equal loudness judgments instead of threshold judgments of scaled input stimuli.

Accordingly, several objects and advantages of the present invention are:

One object and advantage is to provide a stand-alone audio system that optimizes the sound field for both normal hearing and hearing impaired populations.

Another object and advantage is that no external connection (e.g., internet) is required.

Another object and advantage is that no specialized calibration equipment is required.

Another object and advantage is that the device can be set up and used by a single user with no professional help.

Another object and advantage is to provide good quality sound to be output from a low quality device.

Another object and advantage is to create the possibility of using existing equipment with only software modifications to improve sound quality.

Another object and advantage is to provide assistance to hearing impaired users without introducing the stigma associated with wearing a hearing aid.

Another object and advantage is to provide a simple, inexpensive, and private means of assessing hearing loss.

All, some, or none of these objects and advantages may be present in various embodiments of the present invention. Other technical advantages will be readily apparent to one skilled in the art from the following figures, descriptions, and claims.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram of one possible embodiment of the audio system in which the audio system and sound optimization process are part of the same overall system.

FIG. 2 is a block diagram of a system that can be included with any of the embodiments to test the user's preference for the filtered or unfiltered sound.

FIG. 3 is a block diagram of one possible embodiment of the audio system in which a CD is used by a listener to set up an off-the-shelf audio system to be optimized for the listeners hearing and the audio systems frequency response.

FIG. 4 is a block diagram of one possible embodiment in which the sound optimization process is done through a computer or personal listening device and the output is played directly from the filtered signal.

FIG. 5 is a block diagram of one possible embodiment in which the sound optimization process and filtering of the signal is followed by saving the filtered signal for future use.

### DETAILED DESCRIPTION OF THE PREFERRED EMBODIMENT

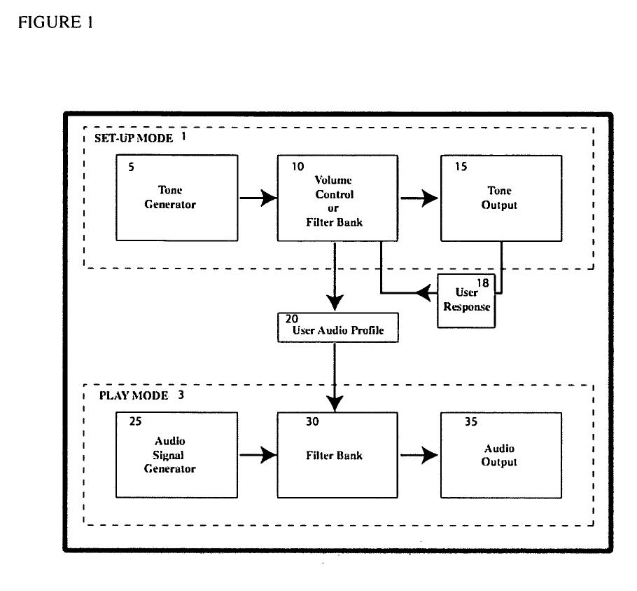

A detailed description of the various embodiments of the present invention is provided with reference to FIGS. 1, 2, 3, 4 and 5. The invention provides a method to optimize the audio output for a specific ear and this can be done without any additional equipment. Embodiments of this aspect of the invention are discussed below. However, those skilled in the art will readily appreciate that the detailed description given herein with respect to these figures is for explanatory purposes as the invention extends beyond these limited embodiments.

FIG. 1 illustrates a block diagram of the stand-alone system of the present invention that can optimize audio output for a given individual's hearing. The system is comprised of two functional parts: the set-up mode [1] and the play mode [3]. Electronic memory and logic, not explicitly indicated in FIG. 1, controls aspects of both modes.

The set up mode [1] is comprised of several steps that determine the hearing profile of a single ear of the user. It can be repeated for both the left and the right ears when headphones are used to listen to the audio output, or it can be performed once when free-field speakers are used. In the set-up mode [1], the tone generator [5] generates tones at specified test frequencies. For example, the test frequencies could be at the audiometric frequencies of 250, 500, 1000, 2000, 4000, and 8000 Hz, although other and additional frequencies could also be used. The amplitudes of these tones at the test frequencies are scaled so that the relative amplitudes of the tones at all test frequencies correspond to a desired method of determining the hearing profile. For example, the relative amplitudes of sound pressure waves at the test frequencies could be the relative amplitudes of sound waves at the threshold of hearing, such as those determined from the international standard ISO 389-1:1998(E) (Table 1, column 2) for threshold sound pressure levels for pure tones and TDH 39 supra-aural earphones. For systems with alternate types of earphones or free field listening, alternative threshold standards could be applied in the same manner. Using these ISO standards, tones at all test frequencies are generated with amplitudes scaled relative to one another as indicated here, with amplitudes normalized to 1 at 1000 Hz.

| Frequency (Hz) | Amplitude |
|---|---|
| 250 | 8.4 |
| 500 | 1.7 |
| 1000 | 1 |
| 2000 | 1.3 |
| 4000 | 1.3 |
| 8000 | 2 |

Similarly, for some applications (e.g., loud music, hearing impaired persons), the hearing profile might be found through amplitudes that are scaled relative to equal loudness contours and not threshold. Alternatively, the amplitudes could also apply a nonlinear scaling from threshold to account for the abnormal growth of loudness that sometimes occurs with hearing loss.

In the embodiment of FIG. 1, in the set up mode [1] the listener listens to each tone [15] and adjusts the volume control or corresponding filters of a filter bank [10] so that the tone is just barely audible. The electronic control within the system keeps track of the volume or filter adjustments made by the user—noted as the user response [18] in FIG. 1—at all test frequencies. These volume or filter adjustments correspond to a known sound-level output, and the electronic control within the system then uses the results from the volume or filter adjustments to determine a “user audio profile” [20] for the given listener. This user audio profile [20] describes how each test frequency should be amplified, relative to the other test frequencies, so that all frequencies within an audio signal can be scaled to account for any frequency-dependent hearing loss of the listener as well as frequency-dependent characteristics of the audio system. The user audio profile [20] can be stored for multiple users and needs to measured only once for each person.

In the play mode [3], the audio signal is filtered by the filter bank [30] so that the output audio signal [35] is optimized for the hearing of the listener. The user audio profile [20] is used by the electronic control to set the gains of band-pass filters that compose the filter bank [30]. The gains of the filters in the filter bank [30] are set so that the gain corresponding to the band-pass filter centered at each test frequency corresponds to the volume control level that led to a just audible response during the set-up mode [1].

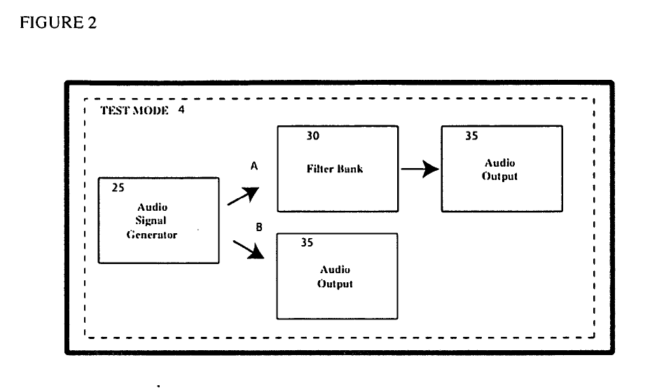

FIG. 2 illustrates an additional embodiment of the invention to be added to that of FIG. 1. Here, the system is comprised of three functional parts: the set-up mode [1] (FIG. 1), the play mode [3] (FIG. 1), and the test mode [4] (FIG. 2). The description is the same as for FIG. 1 except for the test mode [4]. In the test mode [4], the user listens to a sample music clip with a wide bandwidth under two conditions: (1) using the filter bank with the user audio profile and (2) bypassing the filter bank. Through adjusting between the two modes—positions A and B of FIG. 2—the listener compares the music listening experience between the two settings. Depending on personal preferences, the listener can choose to use the user audio profile data stored in memory or to reject it. The test mode serves as a basic control system that allows the user to decide whether the user audio profile is indeed the preferred setting.

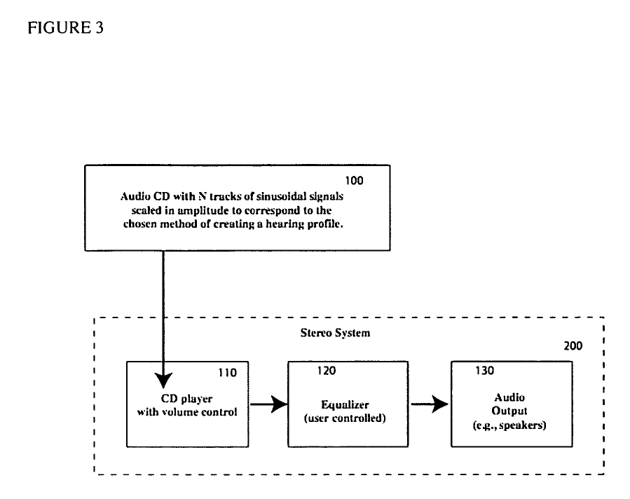

FIG. 3 illustrates an alternative embodiment of the invention. In this case, the invention is in the form of an audio CD with tracks that correspond to a number N of tones, each at frequency ƒᵢ where i=1, 2, . . . N, and each sinusoid is scaled in amplitude to correspond to a method to determine a hearing profile, such as the threshold of hearing in normal ears at ƒᵢ [100]. The N tones would correspond to the center frequencies found on typical audio equalizers [120]. This CD [100] is used in conjunction with a stereo system [200] with off-the-shelf components that could include a CD player [110], a user-controlled equalizer [120], and an audio output (e.g., speakers) [130]. The CD [100] allows the user-controlled equalizer [120] within the stereo system [200] to be set to optimize the sound field for a listeners hearing and the frequency characteristics of the stereo system. Specifically, the user is instructed to listen to the CD [100] with the external stereo system [200]. The user systematically listens to all tones on the CD [100] with the volume control of the stereo system [200] fixed at one level and determines the track on the CD [100] that sounds loudest—call this track T_{ref} for reference track. The user then listens to the track T_{ref} and adjusts the volume control of the stereo system so that the tone on track T_{ref} is just barely audible. The volume control [110] is then left at this fixed position. Next, the user listens systematically to all tracks (except T_{ref}) of the CD [100] that correspond to the center frequencies of the user's equalizer [120]. For each frequency ƒᵢ on the CD [100] the user adjusts the corresponding equalizer [120] gain at center frequency ƒᵢ to a level such that the tone is just barely audible.

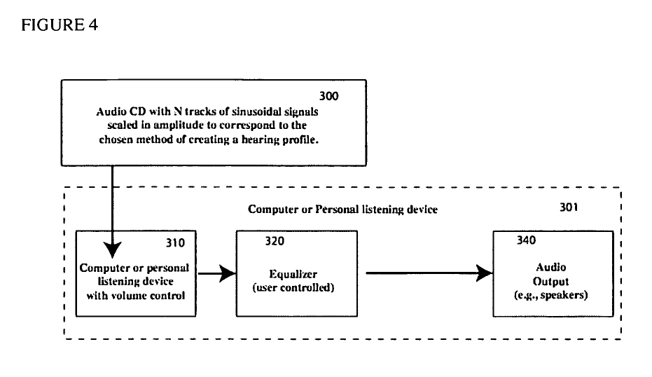

FIG. 4 illustrates an alternative embodiment of the invention. In this case, the invention is of the form of FIG. 3, except that the sound [300] is played through an electronic device such as a computer or personal listening device [301] that includes a volume control and an equalizer [320]. The calibration process described in connection with FIG. 3 is identical for this case.

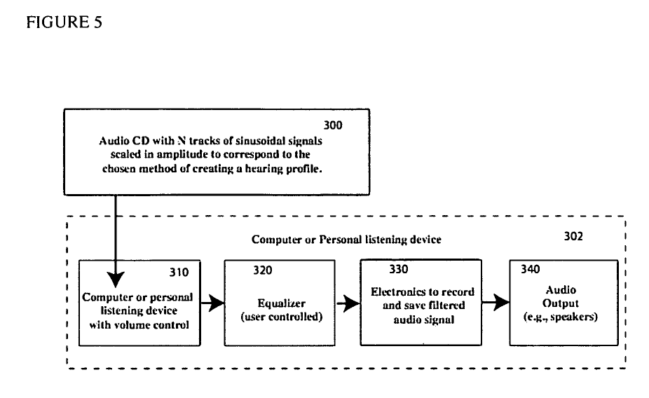

FIG. 5 illustrates an alternative embodiment of the invention. In this case, the invention is of the same form as FIG. 4, except that it also permits the output of the equalizer [320] to be recorded or saved in electronic format [330], potentially for future use.

The presentation in FIGS. 1-5 provide an overview of the invention. While the present invention is disclosed by reference to these embodiments and examples in FIGS. 1-5, it is to be understood that these examples are intended in an illustrative rather than in a limiting sense. For example, this invention may include modifications to include application to several media, including but not limited to, television, car stereo systems, internet calibration of equalizer settings, communication technologies, cellular phones, and custom recording of music for individual hearing profiles.

Thus, it is an important aspect of the present invention that a method and a device has been proposed that permits a systematic optimization procedure that accounts for both the frequency response of the audio system as well as the frequency response of the listener. In this manner, the invention compensates for the hearing impairments of a particular individual, while also compensating for any inherent distortion that the audio equipment may introduce into the audio output.

It will be readily appreciated that a hearing aid that has been calibrated upon the absolute frequency threshold of an individual cannot compensate for the audio distortions inherent in the wide range of audio devices available in today's marketplace. That is, an individual's hearing aid may be properly calibrated upon the individual's absolute frequency threshold, in the abstract, but still fail to give satisfactory performance in dependence upon the audio capabilities and inherent distortions created by a particular television set, stereo system, radio or other audio equipment.

The method and device of the present invention is therefore envisioned to be either a stand alone system, or a component of a larger electronic device, such as a television set, stereo system or the like. In this manner, the present invention may give real-time feedback to an individual as to the relative thresholds of multiple frequency bands, all while also compensating for the audio characteristics and inherent distortions of the audio equipment. Thus, the present invention address both the physiological state of the individual, as well as the technological capabilities of the audio equipment to which the individual is listening.

It is another important aspect of the present invention that an individual's audio profile need not be known prior to employing the method and device of the present invention. Indeed, quite apart from requiring the application of known and oftentimes expensive audiograms in order to determine an individual's audio profile, and thus the absolute hearing threshold of the individual at given frequencies, the present invention instead utilizes the relative thresholds between audio frequencies to determine the necessary frequency response of the audio system. As discussed above, the relative nature of the analysis undertaken by the present invention permits a level of customization and a clarity of hearing that is simply heretofore unknown in the art.

It is contemplated that modifications and combinations will readily occur to those skilled in the art, which modifications and combinations will be within the spirit of the invention and the scope of the appended claims.

What is claimed is:

1. A method for customizing an audio component capable of issuing an audio signal, comprising the steps of:
generating scaled tones at n number of frequencies, n being any whole number greater than or equal to 1;
modifying said scaled tones via a filter bank with adjustable gains at said n number of frequencies;
determining a hearing profile based upon said modification of said scaled tones at each of said n number of frequencies; and
outputting said audio signal as modified by said hearing profile.

2. The method of claim 1, further comprising the steps of:
storing said hearing profile; and
applying said hearing profile to any audio signal.

3. The method of claim 2, wherein:
multiple hearing profiles may be stored.

4. The method of claim 1, wherein:
said adjustable gains include a volume control.

5. The method of claim 1, further comprising the steps of:
scaling said tones relative to normal-hearing threshold measurements made without earphones.

6. The method of claim 1, further comprising the steps of:
scaling said tones relative to normal-hearing threshold measurements made with earphones.

7. The method of claim 1, further comprising the steps of:
scaling said tones relative to equal loudness contours at a specific loudness level.

8. The method of claim 1, wherein:
said audio component is a speaker associated with a sound system.

9. The method of claim 1, wherein:
said audio component is an audio headphone set associated with a sound system.

10. The method of claim 1, wherein:
said audio component is a computer with speakers.

11. The method of claim 1, wherein:
said audio component is a cell phone.

12. The method of claim 1, wherein:
said scaled tones are generated on a computer.

13. The method of claim 1, wherein:
said scaled tones are played through a compact disc.

14. The method of claim 1, wherein:
said scaled tones are saved to a computer and played through said computer.

15. The method of claim 1, wherein:
said scaled tones are played through a personal listening device.

16. The method of claim 1, wherein:
said scaled tones are transmitted via the Internet.

17. A method to test user preference for a customized audio output as compared to an alternative audio output, comprising an audio output that the user can toggle between multiple settings to compare the effects of the application of various audio filters on the signals.

18. A method for customizing an audio experience, said method comprising the steps of:
outputting audio test signals at a plurality of discreet frequencies and gains;
modifying said gains at each of said frequencies until said audio test signals are barely audible;
creating a hearing profile based upon said modification of said gains at each of said frequencies; and
applying said hearing profile to subsequent audio signals.
